(19) United States
(12) Patent Application Publication
(10) Pub. No.: US 2026/0187639 A1
(43) Pub. Date: Jul. 2, 2026

(54) Supervised and Transferred Learning Techniques for Detecting Fraud or Abuse Relating to Service Events

(71) Applicant: UnitedHealth Group Incorporated, Minnetonka, MN (US)

(72) Inventors: Mark Robert Kanner, West Hartford, CT (US); Qi Fang, Allen, TX (US)

(21) Appl. No.: 19/007,160

(22) Filed: Dec. 31, 2024

(51) Int. Cl. G06Q 20/40; G06N 20/00

(52) U.S. Cl. CPC G06Q 20/4016; G06N 20/00

(57) ABSTRACT

The disclosed techniques relate to a supervised machine-learned (ML) model trained to determine the presence of fraud or abuse in indications of services rendered by one or more service provider (e.g., a hospital, clinic, etc.) to one or more service recipients (e.g., one or more patients). To leverage the supervised ML model for data of a different type than the data used to train the supervised ML model, the disclosed techniques transform an input dataset into a transformed input dataset having the data structure of the labeled training data, thereby enabling the supervised ML model to perform effectively with respect to the transformed input dataset (e.g., with high recall, accuracy, and/or precision).

### BACKGROUND

Fraudulent indication of services rendered by service providers is a pervasive problem that is notoriously difficult to detect. Fraudulence can include services that were not actually rendered or were otherwise inappropriately documented. Failure to detect intentional fraud or other incorrect claims incentivizes further intentional fraud via similar methods. Moreover, even when fraud is detected, bad actors consistently develop new methods for avoiding those detection mechanisms. It is desirable to detect and deter all forms of fraud and abuse, including any existing common methods and any methods that may emerge in the future.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing environment in which various embodiments of the present disclosure can be implemented.

FIG. 2 depicts an example process of training and using a supervised machine-learned model.

FIG. 3A depicts example service event data from which a first portion of a labeled training dataset for a supervised machine-learned model is generated.

FIG. 3B depicts example exclusion data from which a second portion of a labeled training dataset is generated.

FIG. 3C depicts an example labeled training dataset.

FIG. 3D depicts example input data indicating service events.

FIG. 3E depicts an example transformed input dataset.

FIG. 3F depicts example outputs of a supervised machine-learned model.

FIG. 4 depicts a flow diagram of an example computer-implemented method.

### DETAILED DESCRIPTION

In various fields, providers of services may bill a payer for services when those services were not performed at all, or may “upcode” services by indicating that the provider rendered a more expensive service(s) when the payer actually rendered a less expensive service(s). In the healthcare field, for example, these services may include imaging services, blood tests, consultations, providing of drugs, etc. In still other examples of fraud or abuse, a recipient of a service may not accurately or fully indicate his or her identity, relationships, history of self or a covered entity, symptoms, etc., in the interest of obtaining services that a provider may not otherwise provide to the recipient. One or more parties may commit these instances of fraud and abuse by repeatedly using tried methods or schemes, the existence of which payers may or may not be aware. Thus, there is a need for technologies that can identify existing fraud and abuse schemes, and detect instances of actors executing the fraud and abuse schemes thereafter. Moreover, even if a payer were to identify all existing fraud and abuse schemes, financial incentives for bad actors are such that new, covert new schemes would emerge over time. Thus, in addition to identifying and detecting existing schemes, there is a need to identify new fraud and abuse schemes as they emerge. Identifying existing and new schemes for fraud and abuse via analysis of electronic records is particularly difficult in view of the practical limitations of the types and amounts of electronic information that is captured about services when those services are rendered.

One potential way to detect fraud and abuse involves subject matter experts defining business rules for detecting or flagging claims of rendered services as potentially corresponding to fraud. For example, a data mining system could be programmed to execute the defined rules such that, when a data representing a claim of a rendered service satisfies or fails to satisfy defined rules, the system either (1) determines that the claim is fraudulent or otherwise inaccurate, or (2) flags the claim as suspicious (e.g., potentially indicative of fraud and/or abuse) for further analysis of the claim (e.g., by a subject matter expert or via processing of further business rules). Such techniques, though potentially effective in detecting at least some fraud or abuse schemes that trigger the defined rules, are deficient in that the techniques are constrained by the extent to which subject matter experts can imagine business rules that robustly define fraud and abuse or account for potential fraud and abuse schemes. Furthermore, the efficacy of these first techniques reduces over time, as bad actors redirect their efforts toward alternate schemes that the existing rules do not capture.

Another potential way of detecting fraud and abuse in healthcare use cases involves training and applying an unsupervised machine-learned (ML) model to detect patterns and/or anomalies in data representing claims of rendered services. According to these techniques, the provided data is unlabeled, i.e., the data does not explicitly indicate whether a given claim is or is not associated with fraud or abuse. Anomalous data may correspond to fraud and/or abuse, or at least to claims to be evaluated further (e.g., by a subject matter expert). A significant drawback of these techniques, however, is that determined patterns and anomalies might not correspond to either fraud or abuse. That is, the unsupervised ML model may detect patterns or anomalies based on different criteria altogether, regardless of the legitimacy of the claims. Accordingly, these second techniques suffer from at least some of the same setbacks as the aforementioned first techniques by requiring further efforts of a subject matter expert and/or another computing system over time, in this case to verify or override outputs of the unsupervised ML model.

To overcome the deficiencies of the above-noted techniques, another potential way of detecting fraud and abuse in healthcare use cases involves training and applying a supervised ML model. Generally, the supervised ML model is trained and applied to detect whether data representing claims of services rendered (“service events”) is indicative of potential insurance fraud or abuse, based on labeled training data that specifically indicates (labels) whether respective portions of the training data are associated with potential insurance fraud or abuse. By using labeled training data, the supervised ML model techniques improve over unsupervised ML model techniques in that outputs of the supervised ML model specifically indicate potential association of claims data with potential fraud and/or abuse, in contrast to the unsupervised ML model techniques by which output may instead indicate other unusual (but legitimate) patterns.

To the extent that the outputs of the supervised ML model are accurate, the supervised ML model techniques may reduce or avoid the need for secondary verification of model outputs by a subject matter expect and/or another computing system.

In view of these advantages, supervised learning approaches are generally preferable for fraud and abuse detection. However, a lack of available labeled training data can present a significant impediment to implementing the supervised ML model techniques described above. For example, in the field of healthcare claims data, training or re-training a supervised ML model to accurately detect fraudulent or abusive claims may require a large volume of corresponding labeled training data (e.g., data indicating possibility, likelihood, or certainty of fraud/abusive).

In practice, such labeled training data for healthcare and/or other claims is difficult to acquire and/or curate in large quantities, thus presenting an obstacle to training, fine-training, and/or using a supervised ML model for fraud and/or abuse detection.

To address these challenges of supervised learning for fraud and abuse detection, the present disclosure uses a combination of supervised learning and transferred learning techniques. In particular, the disclosed techniques use, as the training dataset(s), data having a different data structure than the data on which the trained model is to be used for inference. In some use cases, for example, one or more third parties may individually or collectively gather, maintain, and/or curate first data that, while not having the structure of second data on which the trained model is to be used, is better labeled (and/or more voluminous, etc.) than the second data, and thus is better suited for use in the training process. In the healthcare claims data setting, for example, the United States Centers for Medicare and Medicaid Services (CMS), and/or another one or more public entities, may provide a publicly available database of claims data indicating service events. Additionally, in the healthcare claims data setting, the United States List of Excluded Individuals/Entities (LEIE) and/or another one or more public data sources, may provide a publicly available database indicating fraud and abuse outcomes associated with certain claims that are represented in the CMS database. Collectively, therefore, the data sources (and/or similar entities/databases) offer a rich source of labeled claims data. Thus, in an example embodiment, the present techniques may merge these data sources to obtain a labeled training dataset, and use the labeled training dataset to train a supervised ML model. A problem remains, however, in that a supervised ML model trained in this manner is generally not able to operate effectively (e.g., with high accuracy, precision, recall, etc.) on the differently-structured data for which the supervised ML model is desired in operation (e.g., the data of an individual payer, etc.). To address this problem, the disclosed techniques also transform novel input data to align with a data structure of the training dataset, thereby enabling the supervised ML model to operate more effectively (e.g., with higher accuracy, precision, recall, etc.) on that data. As used herein, the term “novel” data (e.g., “novel input data” or a “novel input dataset”) refers to data for which the supervised ML model has not been used for inference to identify potential fraud and/or abuse (or lack thereof).

Techniques of this disclosure provide various technical advantages. For example, the supervised ML techniques described herein enable one or more computers to determine new and existing trends in fraud or abuse in a manner not possible via other methodologies, including many other ML model methodologies. Additionally, the transforming of novel input data to align with the structure of the training dataset enables the use of other datasets (e.g., larger and/or better labeled datasets) for training of the supervised ML model, which in turn facilitates better operation (e.g., higher accuracy, recall, precision, etc.) of the trained supervised ML model than would be the case if the novel input data were required to have the same data structure as the training data.ad

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art.

While examples discussed or shown herein refer primarily to the healthcare field with patients, healthcare providers, and rendered healthcare services, it is to be understood that the disclosed techniques and embodiments can instead or additionally be applied in other fields that involve service events to be evaluated for potential abuse or fraud (e.g., financial fields).

Moreover, as used herein, the term “provider” can refer to an individual (e.g., a doctor), an organization (e.g., a clinic, a hospital, etc.), or any other entity associated with the provision of services. The term “payer” can refer to an organization (e.g., an insurance company) that receives claims of services rendered by providers (e.g., from the providers themselves, and/or from other interested parties), adjudicates the claims of services to determine an extent to which the provider is to be reimbursed for the rendered services, determines whether claims of services are potentially associated with abuse or fraud, and/or reimburses providers when the foregoing actions determine that the providers rendered the services as accurately and thoroughly claimed. Further, as used herein, the term “fraud” can generally refer to intentionally inaccurate or incomplete claiming of services rendered, often but not necessarily with the specific interest of financial or other gain for an individual or group. The term “abuse” can more broadly refer to various improper claiming of services provided, whether or not said improprieties are intentional or produce financial or other gain. A “fraud and abuse scheme” can refer to a shared method (or portion thereof) by which one, two, three or more actors perform any number of instances of fraud and/or abuse, for example.

### EXAMPLE COMPUTING ENVIRONMENT

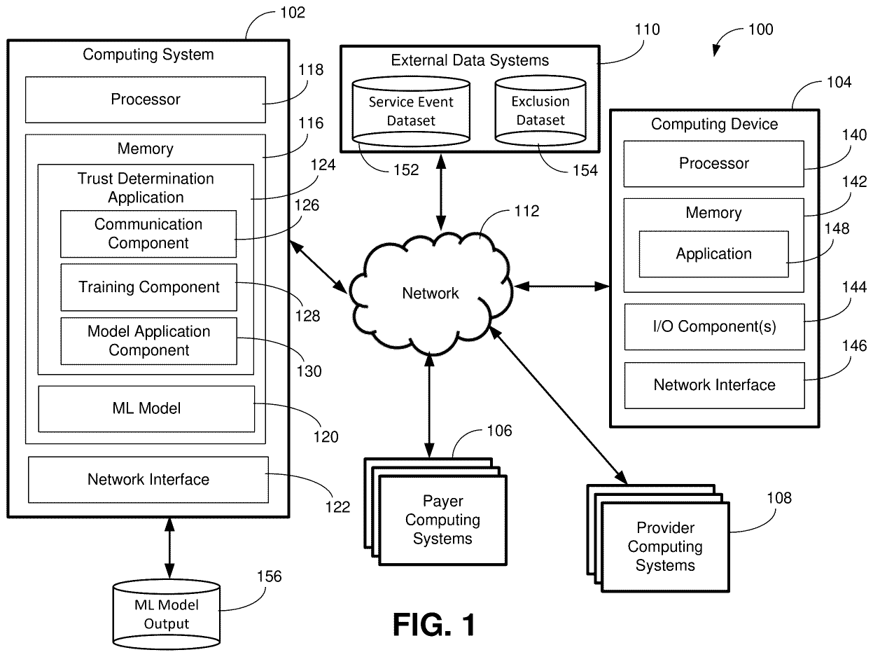

FIG. 1 depicts an example computing environment 100 in which various embodiments of the present disclosure may be implemented. Generally, the example computing environment 100 includes a computing system 102, a computing device 104, and a number of payer computing systems 106, provider computing systems 108, and/or external data systems 110.

Some or all of these devices and/or systems are communicatively coupled via a network 112.

The computing system 102 includes a memory 116 (i.e., one or more memories), and a processor 118 (i.e., one or more processors). At a high level, the computing system 102 is configured to, via the processor 118, obtain, train, apply, and/or re-train a supervised machine-learned (ML) model 120 (i.e., one or more models) to determine fraudulent and/or abusive claims of services rendered by one or more providers to one or more persons or entities. More specifically, in embodiments, the supervised ML model 120 (also referred to herein as simply “ML model”) determines, for any service event including one or more claims of one or more services rendered, a corresponding value of a trust parameter indicating whether the service event is fraudulent or abusive (e.g., whether one or more claimed services indicated therein was fraudulent or abusive). The supervised ML model 120 is trained (e.g., at the computing system 102 via the processor 118, and/or by another system) based on a labeled training dataset including, for a first plurality of service events, respective labels indicating respective values of the trust parameter for respective ones of the first plurality of service events. In some embodiments, the computing system 102 stores the ML model 120 at the memory 116, and/or accesses the ML model 120 from another location over the network 112 via a network interface 122 (i.e., one or more network interfaces).

A service in a healthcare field may, for example, include a primary care service, a particular type of surgery (e.g., orthopedic surgery, or more specifically knee surgery, etc.), an administration of a drug or medical device, etc. Various other examples in the healthcare field will be evident from this disclosure. In other fields, rendered services may for example include automotive care or repair services (in the field of automotive insurance), home repair and/or improvement services (home insurance), or repair and/or replacement of personal property items (personal property insurance). For any of the above examples, the value of the trust parameter indicates whether the service event is (or is likely to be) fraudulent or abusive, e.g., due to dishonesty, upcoding, other improper recording, etc.

The computing system 102 includes a memory 116 (i.e., one or more memories), and a processor 118 (i.e., one or more processors). At a high level, in some embodiments, the computing system 102 is configured to apply (via the processor 118) the ML model 120 to determine, for any service event, a corresponding value of a trust parameter indicating whether the service event is fraudulent or abusive. In some embodiments, the computing system 102 stores the ML model 120 at the memory 116, and/or accesses the ML model 120 from another location over the network 112 via a network interface 122 (i.e., one or more network interfaces).

The computing system 102 may include a single server, or multiple servers that are co-located and/or remotely distributed, for example. In some embodiments, the computing system 102 includes a cloud platform (e.g., Amazon Web Services (AWS)®, Microsoft Azure®, or Google Cloud®).

The processor 118 may include any suitable number of processors and/or processor types. In some examples, the processor 118 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor 118 comprise hardware configured to execute instructions (e.g., processor-executable code/instructions) stored in the memory 116, and particularly instructions stored in non-transitory portions of the memory 116f.

The network interface 122 includes one or more hardware and/or software components that are generally configured to enable the computing system 102 to communicate, via the network 112, with other components and/or devices of the computing environment 100, such as the computing device 104, the payer computing systems 106, the provider computing systems 108, and/or the external data systems 110. To this end, the network interface 122 includes hardware and/or software that operates in accordance with at least one communication protocol of the network 112. The network 112 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 112 may include both a wireless LAN such as a Wi-Fi® network and a WAN such as the Internet. In some embodiments, the network 112 includes multiple, entirely distinct/parallel networks (e.g., one or more networks for communications between computing system 102 and computing device 104, and one or more separate networks for communications between computing system 102 and another one or more components of the computing environment 100, etc.).

The memory 116 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EPROM (EEROM), NAND flash, and/or solid state drive(s) (SSD(s))), all or any of which are examples of non-transitory computer-readable media. In some examples, the memory 116 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 116 stores the processor-executable instructions of a trust determination application 124 and the supervised ML model 120, with the trust determination application 124 including a communication component 126, a training component 128, and a model application component 130. Functionalities of these components of the trust determination application 124 will be described further herein.

In some embodiments, the memory 116 includes additional, fewer, and/or alternate components to those depicted in FIG. 1. For example, in some embodiments, the memory 116 does not store the ML model 120, and rather communicates with the ML model 120 stored at another location(s) by providing inputs to and receiving outputs from the ML model 120 via the network 112. In some embodiments, the trust determination application 124 does not train or re-train the ML model 120, and the trust determination application 124 excludes the training component 128 (e.g., the ML model 120 is trained by another system(s) and thereafter is provided to or otherwise accessed by the trust determination application 124). Moreover, additionally or alternatively, in various embodiments, some or all of the components of the trust determination application 124 are stored remotely from the computing system 102, and accessed by the computing system 102 via the network 112, e.g., via a cloud service provided by another entity or computing system.

In various embodiments, the computing device 104 is configured to interact with the computing system 102 (e.g., more particularly, the ML model 120) and/or other components of the computing environment 100 over the network 112. In some embodiments, for example, the computing device 104 is associated with a service provider (e.g., medical service provider such as a hospital, clinic, etc.), or service payer (e.g., health insurer), and may for example provide indications of rendered services to the trust determination application 124 (e.g., in the form of provider reports or insurance claims data), and/or receive indications of outputs generated by the ML model 120 (e.g., indicating potentially fraudulent/abusive claims of rendered services).

Accordingly, in at least some of these embodiments, the computing device 104 is part of the payer computing systems 106 and/or the provider computing systems 108. Additionally or alternatively, in some embodiments, an individual or entity uses the computing device 104 to cause acquisition, management, training, and/or re-training of the ML model 120 as described herein, e.g., via communications with other components of the computing environment 100.

Accordingly, in at least some of these embodiments, the computing device 104 is part of the computing system 102.

In any case, the computing device 104 may be a desktop computer, a laptop computer, a tablet device, a mobile device, a wearable device (e.g., augmented or virtual reality glasses/headsets), or any other suitable computing device. At a high level, the computing device 104 includes a processor 140, a memory 142, one or more input/output (I/O) components 144, and a network interface 146.

The processor 140 (i.e., one or more processors) may include any suitable number of processors and/or processor types. In some examples, the processor 140 includes one or more CPUs, one or more GPUs, one or more TPUs, one or more FPGAs, one or more ASICs, and/or the like. Generally, the processor 140 comprises hardware configured to execute instructions (e.g., processor-executable code/instructions) stored in the memory 142. The memory 142 (i.e., one or more memories) may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 142 stores one or more of:
an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, non-transitory portions of the memory 142 store the processor-executable instructions of an application 148 (i.e., one or more applications) which enable and/or cause the computing device 104 to perform any of various actions attributed herein to the computing device 104 (e.g., directing the acquisition, training, and/or re-training of the ML model 120, facilitating the provision of service event data to the ML model 120, receiving indications of outputs of the ML model 120 etc.).

The I/O component(s) 144 include hardware and/or software that generally enables a user of computing device 104 to interact with the computing device 104. The I/O component(s) 144 may include one or more input components that enable a user of computing device 104 to enter inputs to the computing device 104 (e.g., a keyboard, a microphone, etc.), one or more output components that enable the user to perceive outputs generated by the computing device 104 (e.g., a monitor/display, a speaker, a haptic feedback component, etc.), and/or one or more integrated I/O components (e.g., a touchscreen). The I/O component(s) 144 may use any suitable technology or technologies, such as LED, OLED, or LCD display technology, for example.

While FIG. 1 shows computing device 104 as a single component, in some implementations the components of computing device 104 shown in FIG. 1 are instead divided among two or more client/user-side devices. As just one example, a pair of smart glasses may include one portion of the processor 140, at least a portion of the memory 142, and a display of the I/O component(s) 144, while a smartphone may include another portion of the processor 140, another portion of the memory 142, a touchscreen of the I/O component(s) 144, and the network interface 146. The smart glasses may then communicate as needed with the smartphone (e.g., via Bluetooth®) to enable the operations described herein.

The network interface 146 includes one or more hardware and/or software components that are generally configured to enable the computing device 104 to communicate, via the network 112, with other components and/or devices of the computing environment 100, such as the computing device 104. To this end, the network interface 146 includes hardware and/or software that operates in accordance with at least one communication protocol of the network 112.

While not explicitly shown in FIG. 1, one, some, or all of the payer computing systems 106, one, some, or all of the provider computing systems 108, and/or one, some, or all of the external data systems 110 may have components (e.g., processor(s), memory, network interface, and possibly I/O component(s)) similar to computing system 102 or computing device 104.

In some embodiments, the ML model 120 is trained (e.g., by the computing system 102) based on a labeled training dataset obtained or derived from contents of the external data systems 110 (e.g., via the communication component 126). In some embodiments, the labeled training dataset is extracted or derived (e.g., by the computing system 102) from respective datasets maintained and/or provided by two discrete data sources. A first dataset corresponds to at least a portion of service event dataset 152. Service event dataset 152 incudes data indicative of services previously rendered by various service providers to various service recipients. The second dataset from which the labeled training dataset is derived corresponds to at least a portion of exclusion dataset 154. Exclusion dataset 154 includes data indicative of persons and/or other entities known to have previously been associated with fraudulent and/or abusive claims with respect to rendered services. By merging the first and second datasets, the computing system 102 (e.g., training component 128) labels portions of the first dataset (e.g., labels subsets of data that are each associated with a different service event and/or claim) with respective values of a trust parameter based on the second dataset. For example, the trust parameter values may indicate whether respective service events from service event dataset 152 are associated with at least one person or other entity listed in the exclusion dataset 154. That is, a particular service event, for example, indicating one or more services that were rendered by a provider (or to a recipient) who has previously been associated with fraud or abuse, reduces a confidence that the service event is legitimate (i.e., without fraud and/or abuse). This reduction in confidence may be based on the proposition that a later finding of fraud or abuse in the claim of the one or more rendered services may be the cause of the provider or recipient appearing in the exclusion dataset 154. Alternatively, the particular one or more claimed services may be part of a discovered or undiscovered pattern of fraudulent and/or abusive claims involving the provider or recipient.

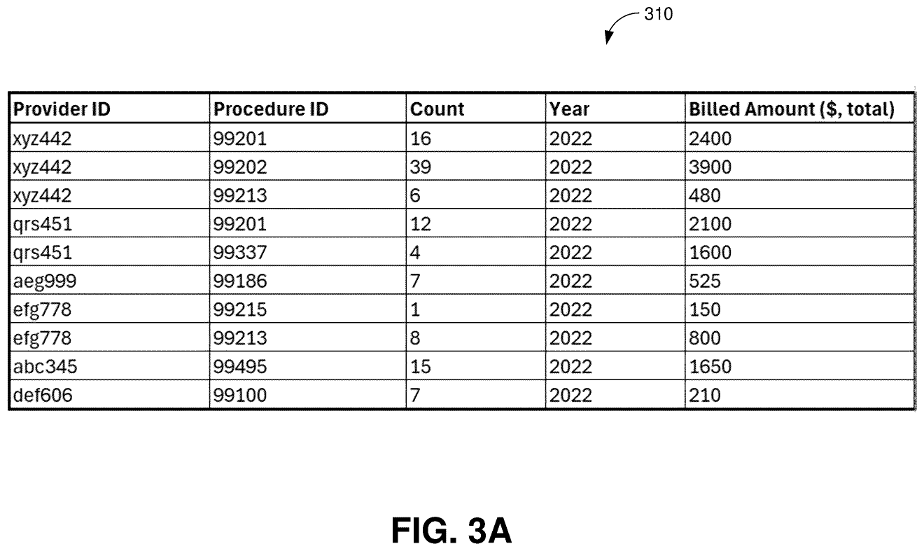

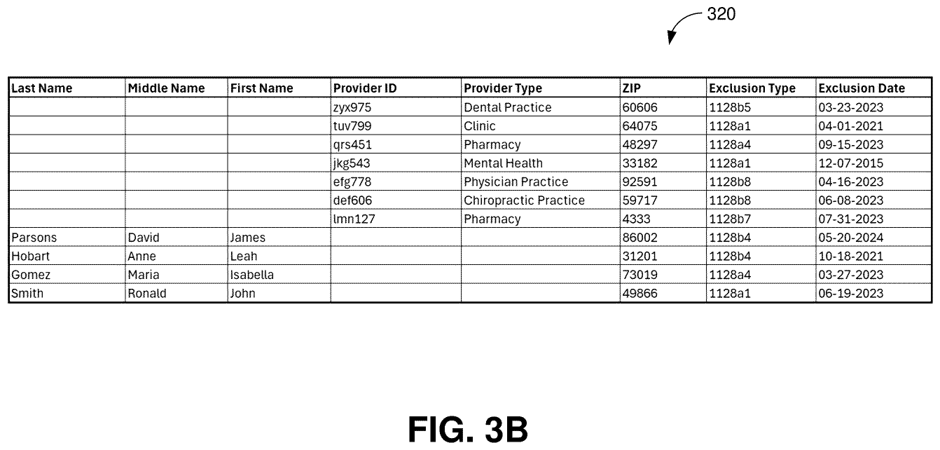

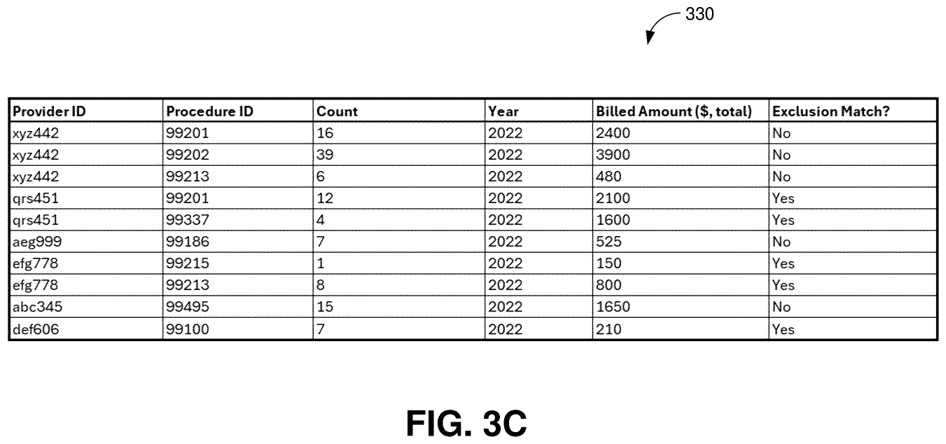

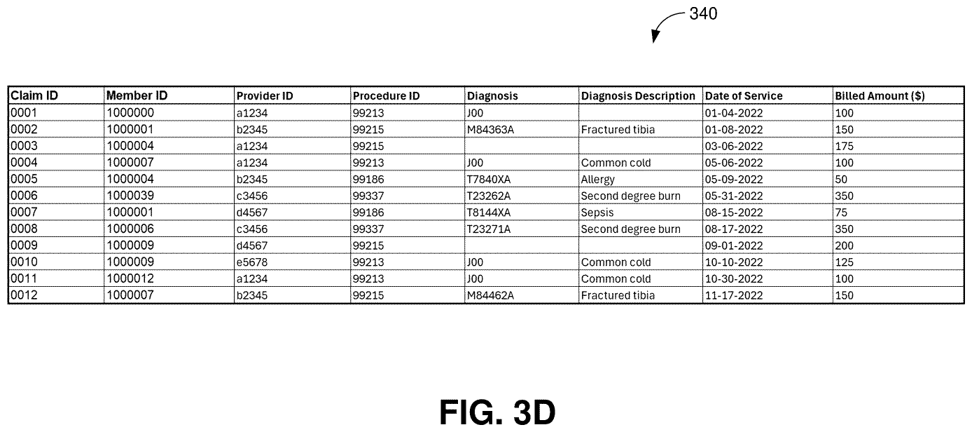

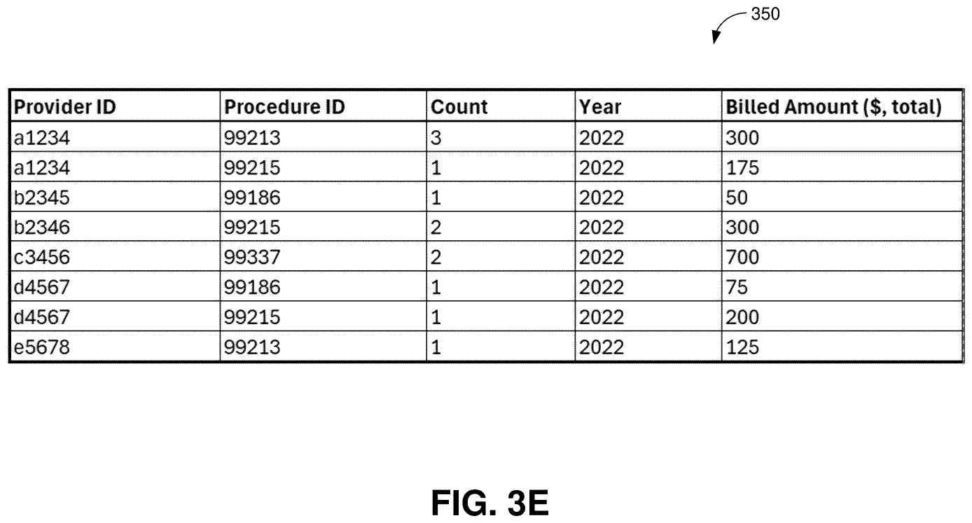

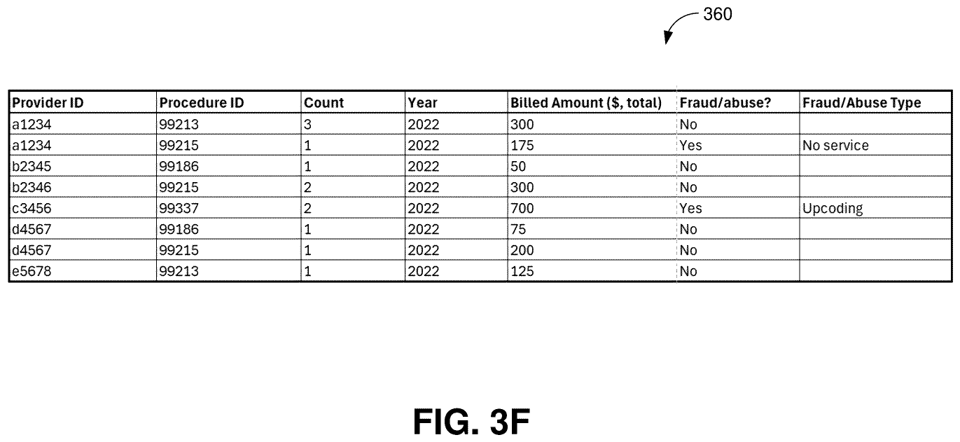

Determining the labeled training dataset may comprise merging the first and second datasets. In an example healthcare implementation, the service event dataset 152 may include data indicating past healthcare services rendered by various providers to various recipients (e.g., including provider identifiers, indicators of recipients, days/months/years of service, billed amounts, unique procedure identifiers, etc.). Such healthcare service event data may, for example, include at least a portion of a dataset of the United States Center for Medicare and Medicaid Services (CMS), which makes the dataset available to the public via the Internet. The exclusion dataset 154, in healthcare implementations, may include indications of individuals and entities excluded from participation of healthcare services and/or healthcare service compensation programs. Such exclusion data may, for example, include at least a portion of the List of Excluded Individuals and Entities (LEIE), maintained by the United States Department of Health and Human Services (HHS) Office of the Inspector General (OIG), identifying persons and entities (e.g., healthcare providers) excluded from eligibility to participate in federal healthcare programs due to previous association with fraudulent and/or abusive healthcare claims. When a service provider and/or recipient (e.g., patient) indicated by a particular healthcare service event from the service event dataset 152 (e.g., CMS data) matches an individual or entity included in the exclusion data (e.g., LEIE, for example based on a matching name, address, National Provider Identifier (NPI), and/or other identifying data), a corresponding value of the trust parameter from the healthcare service event may reduce a likelihood of legitimacy of the service event, based on the proposition that the particular healthcare service event may already be known to be fraudulent or abusive, or may be part of a pattern of fraudulent and/or abusive conduct by the service provider and/or recipient (e.g., identity theft, prescription fraud, billing services not provided, upcoding services, etc.). Operations of example embodiments that use the service event dataset 152 and exclusion dataset 154 will be described in further detail herein, for example with respect to FIGS. 3A-3F.

One or more computing systems train the ML model 120 based on the labeled training dataset. For example, in some embodiments, the training component 128 in the computing system 102 trains and/or re-trains the ML model 120, e.g., after obtaining the labeled training data via communications with the external data systems 110 over the network 112, using the communication component 126 and/or network interface 122. In some embodiments, one or more computing systems other than the computing system 102 include the training component 128 to train the ML model 120. Training of the ML model 120 (i.e., one or more models) uses one or more supervised machine-learning techniques, including for example one or more neural network models, regression analyses (e.g., linear and/or logistic regressions), Naïve Bayesian algorithms, decision trees, classification analyses, support vector machines (SVMs), K-nearest neighbor (KNN) algorithms, K-means algorithms, random forest algorithms, gradient boosting algorithms, adaptive boosting algorithms, dimensionality reduction algorithms, etc. In other embodiments, the ML model 120 comprises one or more generative ML model component(s), such as a transformer-based machine-learned model (e.g., an encoder-only, decoder-only, and/or encoder-decoder architecture, such as a large-language model (LLM), multimodal model, an embedding model, a diffusion model, and/or the like), for example to receive and interpret natural language queries for operation of the ML model 120 and/or to convert outputs of the ML model into a natural language format for presentation to one or more users.

The training and configuration of the ML model 120 may comprise, using service events provided as a novel input dataset to the ML model 120 to determine one or more corresponding outputs, including a value of the trust parameter indicating whether the service event (e.g., at least one rendered service claimed therein) is or may be fraudulent and/or abusive. The ML model 120 may, for example, produce outputs on a normalized, continuous scale between zero and one, where a value of one represents a highest likelihood (e.g., posterior probability) of fraud and/or abuse, and zero represents a lowest likelihood of fraud and/or abuse. In some embodiments, the one or more outputs for any service event(s) provided as input to the ML model 120 include one or more reasons, e.g., that may indicate a type of suspected fraud and/or abuse associated with the service event (for example, upcoding, identity theft, false billing, association with a known dishonest individual or entity, etc.). Advantageously, techniques including reasons for the outputs of the ML model 120 advance upon artificial intelligence techniques by improving interpretability of output via indications of the underlying logic by which the output was produced.

In some embodiments, the computing system 102 stores outputs of the ML model 120 at an ML model output database 156, which may be part of the computing system 102 or separate from the computing system 102.

In operation, in some embodiments, the communication component 126 obtains (e.g., requests and/or receives) indications of service events (and/or requests to analyze service events) over the network 112, e.g., from the payer computing systems 106, provider computing systems 108, and/or computing device 104, any of which may be associated with persons and/or entities motivated to determine fraud and/or abuse in particular service events. Particularly, in some embodiments, indicated service events include post-adjudicated claims of rendered services, i.e., claims previously analyzed by one or more payers to determine respective financial responsibilities of a payer, an intermediary, an end user, etc., presuming legitimacy of the rendered services (i.e., assuming that the claims of one or more rendered services were not fraudulent nor abusive).

Upon generation of outputs by the ML model 120, the communication component 126 provides respective indications of the outputs of the ML model 120 via the network 112 to the payer computing systems 106, provider computing systems 108, and/or computing device 104 (e.g., to corresponding ones of the aforementioned components from which the computing system 102 previously obtained indications of service events and/or requests to analyze service events using the ML model 120).

In some embodiments, upon receiving a novel input dataset indicating one or more service events, the model application component 130 may additionally process the novel input dataset before provision of the novel input dataset to as input to the ML model 120. For example, in some embodiments, the trust determination application 124 may determine that a data structure of the novel input dataset does not align with another data structure of the labeled training dataset from which the ML model 120 was trained. As a more specific example, referring back to the healthcare claim example provided above, the data structure of healthcare service event records provided by healthcare payers and/or providers often do not match the structure(s) of the service event data and exclusion data used to train the ML model 120 (e.g., different fields, different delineations or definitions of certain medical services, etc.). In these scenarios, the model application component 130 transforms the obtained novel input dataset into a transformed input dataset for provision to the ML model 120, where the data structure of the transformed input dataset aligns with the data structure of the training dataset (e.g., aligns completely with the exception that the transformed input dataset does not yet have associated labels indicating likelihood of fraud and/or abuse). Particular examples of this data transformation will be provided in subsequent portions of this disclosure. Advantageously, the transformation of the novel input dataset to align with the structure of the training dataset facilitates enables the ML model 120 to operate more effectively (e.g., with better accuracy, recall, precision, etc.) than would be the case if inputs provided to the ML model 120 did not match the data structure of the training dataset.

In various embodiments, the computing environment 100 can include additional, fewer, and/or alternate components to those depicted in FIG. 1.

### EXAMPLE PROCESS FLOW INCLUDING MACHINE-LEARNED TECHNIQUES

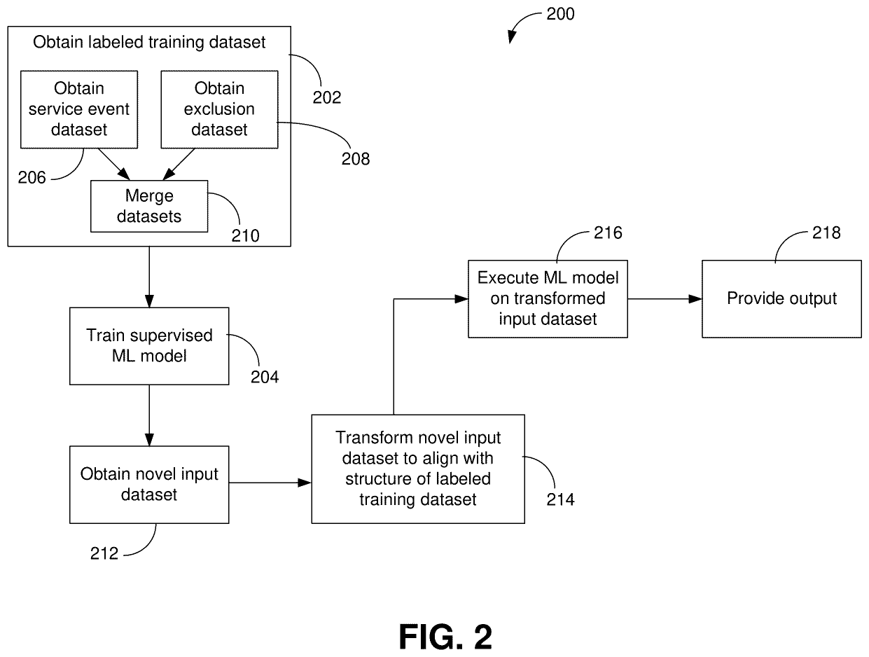

FIG. 2 depicts an example process 200 of training and using a supervised ML model (e.g., ML model 120), in accordance with various embodiments.

While the process 200 can be implemented in other suitable computing environments, the process 200 is described below with reference to elements/components of the computing environment 100. Further, while the process 200 may be implemented with respect to service events associated with various different fields (e.g., claims of rendered services relating to home insurance services, automotive insurance services, life insurance services, credit card services, mortgage services, etc.), actions of the process 200 are described below with respect to example datasets in the field of healthcare as depicted in FIGS. 3A-3F.

At stage 202, the computing system 102 may obtain a labeled training dataset indicative of service events (e.g., claims associated with respective sets of one or more rendered services) and including respective labels in the form respective values of a trust parameter indicating whether the respective service events may be associated with fraud or abuse.

Particularly, in some embodiments, the communication component 126 of the trust determination application 124 obtains the labeled training dataset (or data from which the computing system 102 may derive the labeled training dataset), for example via communications with the external data systems 110 over the network 112. At stage 204, the computing system 102 (e.g., the training component 128) may train the ML model 120 (i.e., one or more supervised ML models) to determine respective values of the trust parameter for data associated with other service events, that is to be subsequently provided as inputs to the ML model 120. Generally, the computing system 102 may train the ML model based on the labeled training dataset indicating the known values of the trust parameter for respective service events indicated by the labeled training dataset. Training of the ML model 120 can include any of the various supervised ML techniques of this disclosure, in various embodiments.

In some embodiments, the computing system 102 may generate the labeled training dataset based on two discrete datasets, which may originate from different respective data sources. Accordingly, in some embodiments, stage 202 includes at least three distinct stages. At stage 206, the computing system 102 (e.g., via the communication component 126) may obtain a first dataset (“service event dataset,” e.g., service event dataset 152) indicating a plurality of services previously rendered by various service providers to various service recipients. At stage 208, the computing system 102 (e.g., via the communication component 126) may obtain a second dataset (“exclusion dataset,” e.g., exclusion dataset 154) indicating one or more persons and/or entities known to have been associated with fraudulent and/or abusive claims of rendered services (e.g., persons/entities excluded from further participation in service and/or insurance programs). The first dataset indicates persons and/or entities associated with the service events therein, and accordingly, at stage 210 the computing system 102 (e.g., via the training component 128) may merge the first and second datasets to create the labeled training dataset by identifying, for each service event indicated by the first dataset, whether a provider and/or recipient associated with the service event appears as an excluded person or entity in the second dataset. Specifically, in some embodiments, the labeled training dataset includes, for each service event indicated by the service event dataset, a respective label indicating whether a person or entity associated with the service event (e.g., a claimed provider or recipient of a service(s)) appears in the exclusion dataset (e.g., based on the trust determination application 124 (e.g., training component 128) identifying that a name, address, identification number, etc. matches from the first dataset to the second dataset). The label is an indication of whether fraud or abuse may be present in the respective service event under the proposition that persons and entities included in the exclusion dataset 154 are likely to have exhibited a pattern of submitting fraudulent and/or abusive claims of rendered services, with the pattern potentially extending to the corresponding service event being labeled).

FIGS. 3A-3C depict example datasets associated with obtaining a labeled training dataset as described above with respect to stage 202.

First referring to FIG. 3A, an example service event dataset 310 includes indications of claims of services rendered (e.g., rendered healthcare services). In some example embodiments, claims of rendered healthcare services may include publicly reported data from the United States Center for Medicare and Medicaid Services, and/or another public entity. In some embodiments, obtaining the service event dataset at stage 206 of the process 200 of FIG. 2 includes obtaining the service event dataset 310 as described herein.

As depicted in FIG. 3A, the service event dataset 310 is characterized by a particular data structure, including at least a plurality of fields. Particularly, in some embodiments, the service event data structure delineates respective data entries (rows or “service events”) by at least (1) a unique identifier of the provider (“Provider ID,” e.g., a national provider identifier (NPI), or alternatively a unique name of the provider, etc.), (2) a unique identifier of the healthcare service rendered (“Procedure ID,” e.g., a Healthcare Common Procedure Coding System (HCPCS) code, a Current Procedural Terminology (CPT) code, etc.), (3) a number of times the healthcare service was rendered in a particular time frame (“Count”), (4) an identifier of the particular time frame (“Year,” or alternatively for example a day, month, quarter, etc.), and (5) a total cost billed by the provider (pre-adjudication) and/or compensated to the provider (post-adjudication) for the one or more renderings of the indicated healthcare service (“Billed Amount ($, total)”). Notably, according to the service event data structure, a single service event indicates a same provider rendering a same healthcare service, one, more than one, or many times over the delineated time frame. That is, for example, provisions of a same service by a same provider to different patients are listed as a same service event, but provisions of a same service by different service providers are listed as separate respective service events. It should be appreciated that, in various embodiments, each service event can include additional, fewer, and/or alternate fields.

Moving to FIG. 3B, an example exclusion dataset 320 includes data indicating persons and/or entities excluded from healthcare services, programs, coverage, etc. In some embodiments in the healthcare field, the exclusion dataset 320 includes publicly available data from the List of Excluded Individuals and Entities (LEIE), maintained by the United States Department of Health and Human Services (HHS) Office of the Inspector General (OIG), identifying individuals and healthcare providers excluded from eligibility to participate in federal healthcare programs due to previous association with fraudulent and/or abusive healthcare claims. In some embodiments, obtaining the exclusion dataset at stage 208 of the process 200 of FIG. 2 includes obtaining the service event dataset 310 as described herein.

The exclusion dataset 320 of FIG. 3B delineates respective entries (rows) by at least (1) an identifier of the excluded individual or entity (e.g., a name of an excluded individual, or a unique identifier of an excluded provider, e.g., a national provider identifier (NPI)), (2) a type of the provider (if applicable), (3) a ZIP code of the individual or provider, (4) an exclusion type (e.g., a statute based upon which the individual or entity was identified as committing fraud or abuse), and (5) a date of the exclusion (e.g., a date the exclusion went into effect, a date on which fraud or abuse occurred, and/or a date on which fraud or abuse was identified). In various embodiments, the exclusion dataset 320 may include additional, fewer, and/or alternate fields (e.g., a physical address, phone number, city, state, provider name, date of reinstatement from the list of excluded persons/entities, etc.).

A portion of the identified providers from service event dataset 310 of FIG. 3A appear on the exclusion dataset 320 of FIG. 3B. In some embodiments, merging the service event dataset and exclusion dataset at stage 210 of the process 200 of FIG. 2 includes merging the service event dataset 310 and the exclusion dataset 320 by labeling service events in the service event dataset 310 with respective values of a trust parameter indicating whether the corresponding respective service provider appears in the exclusion dataset 320. FIG. 3C depicts an example merged dataset derived from the service event dataset 310 and exclusion dataset 320, in accordance with some embodiments. In some embodiments, the value of the trust parameter is delineated as “Yes” or “No” (or, for example, “1” and “0,” respectively). An appearance of the service provider in the exclusion dataset 320 generally indicates an increased likelihood that a corresponding service event involving the service provider includes at least one occurrence of fraud or abuse (e.g., some or all of the indicated services within a given service event were not actually rendered, billed fraudulently, etc.). More particularly, in some embodiments, a value of “yes” (or “1”) indicates that the corresponding service provider was identified for fraud and/or abuse within a particular duration of time following the time range of services rendered, as indicated by the service event dataset 310. For example, in some embodiments, for a set of rendered services claimed in 2022, the value of the trust parameter is set to “yes” on the basis of the exclusion date of the provider being within the following one year (e.g., 2023), two years (e.g., 2023 or 2024), five years, (e.g., 2023 to 2027), etc.

Referring back to FIG. 2, in some embodiments, training the ML model 120 at stage 204 includes training the ML model 120 using the merged dataset of FIG. 3C as a labeled training dataset, i.e., comprised of service events labeled with respective values of the trust parameter. In these embodiments, the training of the ML model 120 thereby enables the model to determine potential fraud and/or abuse in subsequent healthcare service events, as will be described further herein. Advantageously, the use of supervised ML techniques in the ML model 120 enables the ML model 120 to identify patterns or schemes of fraud and/or abuse not previously known to humans and/or to computing systems that may, for example, rely on business rules and/or unsupervised ML models to detect fraud and/or abuse.

Moving onward in the process 200 of FIG. 2, at stage 212, the computing system 102 may obtain a novel input dataset (e.g., via the trust determination application 124, or more particularly the communication component 126, communicating over the network 112 via the network interface 122). In some embodiments, the computing system 102 receives the novel input dataset from the provider computing systems 108 (e.g., from a healthcare service or other service provider seeking to verify its own rendered services), from the payer computing systems 106 (e.g., from an insurance provider seeking to verify service events associated with one or more patients and/or providers), and/or from the computing device 104 (e.g., a computing device associated with the payer computing systems 106 and/or the provider computing systems 108).

Generally speaking, in various embodiments, the novel input dataset is a claims dataset including claims of services rendered by one or more providers to one or more recipients. For example, as depicted in an example healthcare claims dataset 340 of FIG. 3D, healthcare claims may indicate services rendered by healthcare providers to patients.

As depicted in FIG. 3D, the healthcare claims dataset 340 has a particular data structure wherein each respective claim or service event indicates (1) a unique claim identifier (“Claim ID,” e.g., a unique number), (2) a patient identifier (“Member ID”), (3) a provider identifier (“Provider ID,” e.g., an NPI), (4) an identifier of the rendered service (“Procedure ID,” e.g., an HCPCS or CPT code), (5) a diagnosis, if applicable (“Diagnosis,” e.g., an ICD-10 or ICD-9 code”), a diagnosis description, if applicable, (7) a date on which the service is claimed to have been rendered (“Date of Service”), and (8) an amount billed by the provider (pre-adjudication) and/or compensated to the provider by a payer (post-adjudication). It should be appreciated that, in various embodiments, each respective claim record can include additional, fewer, and/or alternate fields.

In some embodiments contemplated herein, the data structure of the novel input dataset is a second data structure that does not align with a first data structure of the labeled training dataset from which the ML model 120 was trained. For example, referring to FIGS. 3C and 3D, the first data structure of the merged dataset 330 (FIG. 3C) does not align with the second data structure of the claims dataset 340 (FIG. 3D). For example, the claims dataset 340 includes fields not present in the merged dataset 330, including for example the patient identifier and the diagnosis code and description for each rendered service. Further, whereas the merged dataset 330 combines multiple claims of a same service by a same provider into one service event, the claims dataset 340 characterizes each provision of a same service as different respective service events. This mismatch is of concern in many possible implementations of the techniques described herein, e.g., where various service providers and/or service payers produce and maintain claims datasets with various data structures that do not align with the particular data structure of the labeled training data of the ML model 120.

Due to the difference between the respective data structure of the labeled training dataset (e.g., merged dataset 330) and novel input dataset (e.g., claims dataset 340), in some embodiments, the novel input dataset is not suitable as input to the ML model 120. That is, the ML model 120 cannot operate effectively on the novel input dataset to produce outputs reliably (e.g., with high accuracy, recall, and/or precision) indicating potential fraud and/or abuse in the novel input dataset. Accordingly, referring back to the process 200 of FIG. 2, stage 214 includes the trust determination application 124 (e.g., the model application component 130) transforming the novel input dataset to align with the data structure of the labeled training dataset. This transformation can, for example, include adding one or more fields to the novel input dataset (e.g., adding respective values of a particular parameter to each service event indicated by the novel input dataset), removing one or more fields from the novel input dataset (e.g., removing values of a particular parameter from each service event indicated by the novel input dataset), merging two or more service events from the novel input dataset (e.g., by combining or otherwise merging respective fields thereof).

In some embodiments, transforming the dataset includes not only modifying the data structure of the dataset, but also modifying one or more values of the dataset (irrespective of structure). For example, transforming the dataset may include rescaling values of one or more parameters from the novel input dataset, e.g., to conform with a numeric range of a corresponding parameter in the labeled training dataset. In some embodiments, the trust determination application 124 rescales parameter values in a non-uniform manner, e.g., so as to align with a distribution (e.g., standard deviation) of the labeled training dataset. In some embodiments, “aligning” with values (or distribution-related metrics, etc.) of the labeled training dataset includes coming within a predefined threshold difference from the labeled training dataset.

An example data transformation at stage 214 can be observed via comparison of the claims dataset 340 of FIG. 3D to a transformed claims dataset 350 of FIG. 3E. Specifically, FIG. 3E depicts the claims dataset 340 of FIG. 3D transformed to align with the data structure of the merged dataset 330 of FIG. 3C. As depicted in FIG. 3E, the transformation produces a transformed claims dataset 350 containing fields arranged as required by the data structure of the merged dataset 330 (with the exception of the trust parameter, as the transformed claims dataset 350 has not yet been analyzed via the ML model 120).

In some embodiments, transforming the claims dataset 340 of FIG. 3D includes modifying values or distributions of values of one or more parameters from FIGS. 3D and/or 3E, e.g., such that a range, average, standard deviation, etc., of parameter values in the transformed claims dataset 350 aligns with corresponding aspects of the labeled training data from FIG. 3C. In particular, for example, the model application component 130 may rescale or normalize values from the “count” and/or “billed amount” columns to produce values having a range, average, or standard deviation within a threshold difference of that present for the “count” and/or “billed amount” columns in the labeled training data of FIG. 3C. Where the model application component 130 adjusts values from one of the “count” or “billed amount” columns are adjusted, the model application component 130 can proportionally adjust values from the other of the two columns, e.g., such that an average billed amount per count of the service remains constant before and after rescaling or normalization of values.

Referring back to the process 200 of FIG. 2, at stage 216, the computing system 102 may execute the ML model 120 on the transformed input dataset (e.g., via the model application component 130). Executing the ML model 120 on the transformed input dataset produces respective values of the trust parameter for service event indicated by the transformed input dataset, thereby indicating for each respective service event the potential presence (or lack of presence) of fraud and/or abuse in at least one service indicated by the respective service event. The respective values of the trust parameter may, for example, include “yes” (1) or “no” (0) values, and/or may indicate a likelihood (e.g., indicated by a normalized value between 0 and 1). In some embodiments, the output of the ML model 120 also includes a determined type of fraud and/or abuse associated with respective service events. Advantageously, analysis of the transformed input dataset using the supervised ML techniques herein provide for determination of fraud and/or abuse according to new or existing fraud and/or abuse schemes that may not be known but for the insights produced by the ML model 120.

With respect to the example healthcare implementations described herein, FIG. 3F indicates example output 360 of the ML model 120, including the transformed claims dataset 350 of FIG. 3E labeled with respective values of the trust parameter indicating potential fraud and/or abuse. In cases where the fraud and/or abuse is determined, the output 360 may further include a type of determined fraud and/or abuse (e.g., services not performed, service upcoding, and/or other types of fraud and/or abuse described in this disclosure).

Referring once again to FIG. 2, at stage 218, the computing system 102 may provide the output of the ML model 120 to one or more entities (e.g., via the trust determination application 124, communication component 126, network interface 122, and/or network 112). In various embodiments, the computing system 102 provides the output to the ML model output database 156, payer computing systems 106, provider computing systems 108, computing device 104, and/or external data systems 110. In some embodiments, providing the output can include causing execution of various user interfaces on one or more components of the computing environment 100 to display the output of the ML model 120. Additionally alternatively, in some embodiments, the computing system 102 may perform (or cause another one or more computing systems to perform) one or more additional actions, including for example accepting and/or rejecting one or more insurance claims based on respective values of the trust parameter determined for claimed services.

In various embodiments, the process 200 can include additional, fewer, and/or alternate actions to those depicted in FIG. 2. As just one example, in some embodiments, stage 202 does not include stage 206, 208, or 210, and instead the computing system 102 obtains the labeled training dataset as a single set of data already labeled (e.g., via the external data systems 110). In another example, in some embodiments, the process 200 does not include stage 202 nor 204, and the ML model 120 is trained via a computing system separate from the computing system 102.

Moreover, in some embodiments, one or more of the actions of FIG. 2 are included in the process 200 but are not performed by the computing system 102 (e.g., the one or more actions are instead performed via other components of the computing environment 100).

### EXAMPLE COMPUTER-IMPLEMENTED METHOD

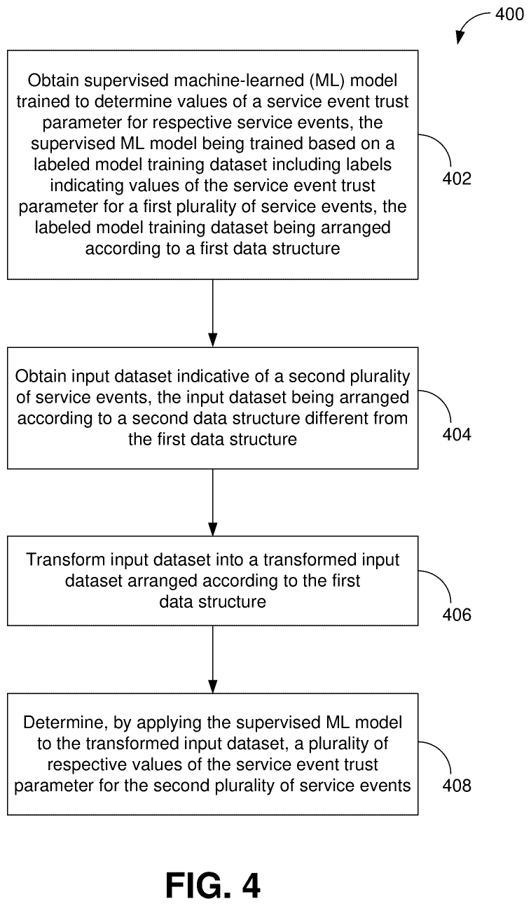

FIG. 4 depicts a flow diagram of an example computer-implemented method 400 associated with applying a supervised ML model (e.g., ML model 120 of FIG. 1) to claims of rendered services, e.g., in the healthcare field (“service events”). The method 400 may be implemented by processor-executable instructions stored in the memory 116 of the computing system 102 (e.g., by the trust determination application 124) when executed by the processor 118.

At operation 402, a supervised ML model is obtained, the ML model being trained to determine values of a service event trust parameter for respective service events. The supervised ML model is trained based on a labeled model training dataset including labels indicating values of the service event trust parameter for a first plurality of service events. The labeled model training dataset is arranged according to a first data structure. In some embodiments, operation 402 includes training the supervised ML model based on the labeled model training dataset, e.g., by (1) obtaining a first dataset indicating the first plurality of service events associated with respective first entities, (2) obtaining a second dataset indicating second entities associated with an indicator of distrust, (3) comparing the first dataset to the second dataset to determine matches between the respective first entities and the second entities, and/or (4) labeling the first plurality of service events with respective values of the service event trust parameter based on whether the respective first entities match the second entities, thereby producing the labeled model training dataset arranged according to the first data structure. In some embodiments, the service event trust parameter indicates whether respective entities associated with the first plurality of service events are associated with at least one instance of fraud or abuse.

At operation 404, an input dataset is obtained, the input dataset being indicative of a second plurality of service events. The input dataset is arranged according to a second data structure different from the first data structure. In some embodiments, a service event from among the second plurality of service events corresponds to a plurality of service actions by a service provider (e.g., serving one, two, three, four or more service recipients).

At operation 406, the input dataset is transformed into a transformed input dataset arranged according to the first data structure. Transforming the input dataset can, for example, include adding, modifying, and/or removing one or more fields of the input dataset, merging two or more service events from among the second plurality of service events, and/or modifying one or more values in the input dataset and/or one or more distributions of values in the input dataset.

At operation 408, the supervised ML model is applied to the transformed dataset to determine a plurality of respective values of the service event trust parameter for the second plurality of service events.

In some examples, the method 400 further includes causing one or more computing devices to display one or more interfaces indicating the plurality of respective values of the service event trust parameter, and/or other outputs of the supervised ML model. Additionally or alternatively, in some embodiments, the method 400 can include accepting and/or rejecting one or more insurance claims based on at least one of the respective values of the service event trust parameter and/or other outputs of the supervised ML model (e.g., to accept a claim when corresponding values of the service event trust parameter indicate that the claim is legitimate, or reject a claim when one or more corresponding values of the service event trust parameter indicate that the claim is fraudulent or abusive).

It is to be understood that the operations of the method 400 may be performed in any suitable order (and/or in parallel), and/or may include fewer, additional, or different operations, in various embodiments. Furthermore, operations of the method 400 may be repeated for further inputs provided to the supervised ML model.

### EXAMPLES

Example 1. A computer-implemented method comprising: obtaining, by one or more processors, a supervised machine-learned (ML) model trained to determine values of a service event trust parameter for respective service events, the supervised ML model being trained based on a labeled model training dataset including labels indicating values of the service event trust parameter for a first plurality of service events, the labeled model training dataset being arranged according to a first data structure; obtaining, by the one or more processors, an input dataset indicative of a second plurality of service events, the input dataset being arranged according to a second data structure different from the first data structure; transforming, by the one or more processors, the input dataset into a transformed input dataset arranged according to the first data structure; and determining, by the one or more processors applying the supervised ML model to the transformed input dataset, a plurality of respective values of the service event trust parameter for the second plurality of service events.

Example 2. The computer-implemented method of Example 1, further comprising training, by the one or more processors, the supervised ML model to determine the values of the service event trust parameter for service events, based on the labeled model training dataset indicating the values of the service event trust parameter for the first plurality of service events.

Example 3. The computer-implemented method of Example 2, wherein training the supervised ML model comprises obtaining the labeled model training dataset by: obtaining a first dataset indicating the first plurality of service events associated with respective first entities; obtaining a second dataset indicating second entities associated with an indicator of distrust; comparing the first dataset to the second dataset to determine matches between the respective first entities and the second entities; and labeling the first plurality of service events with respective values of the service event trust parameter based on whether the respective first entities match the second entities, thereby producing the labeled model training dataset arranged according to the first data structure.

Example 4. The computer-implemented method of any one of Examples 1-3, wherein the service event trust parameter indicates whether respective entities associated with the first plurality of service events are associated with at least one instance of fraud or abuse.

Example 5. The computer-implemented method of any one of Examples 1-4, wherein a service event from among the second plurality of service events corresponds to a plurality of service actions by a service provider.

Example 6. The computer-implemented method of Example 5, wherein the plurality of service actions by the service provider serve different respective ones of a plurality of service recipients.

Example 7. The computer-implemented method of any one of Examples 1-6, wherein determining a trust parameter value from among the plurality of respective values of the service event trust parameter includes determining a type of potential fraud or abuse associated with a corresponding service event from among the second plurality of service events.

Example 8. The computer-implemented method of any one of Examples 1-7, wherein transforming the input dataset includes removing one or more fields for each of the respective service events from among the second plurality of service events.

Example 9. The computer-implemented method of any one of Examples 1-8, wherein transforming the input dataset includes merging two or more service events from among the second plurality of service events.

Example 10. The computer-implemented method of any one of Examples 1-9, wherein transforming the input dataset further includes modifying one or more values in the input dataset or one or more distributions of values in the input dataset.

Example 11. A system comprising: one or more processors; and one or more memories storing processor-executable instructions that, when executed by the one or more processors, cause the one or more processors to perform operations comprising: obtaining a supervised machine-learned (ML) model trained to determine values of a service event trust parameter for respective service events, the supervised ML model being trained based on a labeled model training dataset including labels indicating values of the service event trust parameter for a first plurality of service events, the labeled model training dataset being arranged according to a first data structure; obtaining an input dataset indicative of a second plurality of service events, the input dataset being arranged according to a second data structure different from the first data structure; transforming the input dataset into a transformed input dataset arranged according to the first data structure; and determining, by applying the supervised ML model to the transformed input dataset, a plurality of respective values of the service event trust parameter for the second plurality of service events.

Example 12. The computing system of Example 11, wherein the instructions, when executed by the one or more processors, further cause the one or more processors to perform operations comprising: training the supervised ML model to determine the values of the service event trust parameter for service events, based on the labeled model training dataset indicating the values of the service event trust parameter for the first plurality of service events.

Example 13. The computing system of Example 12, wherein training the supervised ML model includes obtaining the labeled model training dataset by: obtaining a first dataset indicating the first plurality of service events associated with respective first entities; obtaining a second dataset indicating second entities associated with an indicator of distrust; comparing the first dataset to the second dataset to determine matches between the respective first entities and the second entities; and labeling the first plurality of service events with respective values of the service event trust parameter based on whether the respective first entities match the second entities, thereby producing the labeled model training dataset arranged according to the first data structure.

Example 14. The computing system of any one of Examples 11-13, wherein the service event trust parameter indicates whether respective entities associated with the first plurality of service events are associated with at least one instance of fraud or abuse.

Example 15. The computing system of any one of Examples 11-14, wherein a service event from among the second plurality of service events corresponds to a plurality of service actions by a service provider.

Example 16. The computing system of Example 15, wherein the plurality of service actions by the service provider serve different respective ones of a plurality of service recipients.

Example 17. The computing system of any one of Examples 11-16, wherein determining the trust parameter value from among the plurality of respective values of the service event trust parameter includes determining a type of potential fraud or abuse associated with a corresponding service event from among the second plurality of service events.

Example 18. The computing system of any one of Examples 11-17, wherein transforming the input dataset includes removing one or more fields for each of the respective service events from among the second plurality of service events.

Example 19. The computing system of any one of Examples 11-18, wherein transforming the input dataset includes merging two or more service events from among the second plurality of service events.

Example 20. The computing system of any one of Examples 11-19, wherein transforming the input dataset further includes modifying one or more values in the input dataset or one or more distributions of values in the input dataset.

Example 21. One or more non-transitory computer-readable media storing instructions that, when executed by one or more processors, cause the one or more processors to perform operations comprising: obtaining a supervised machine-learned (ML) model trained to determine values of a service event trust parameter for respective service events, the supervised ML model being trained based on a labeled model training dataset including labels indicating values of the service event trust parameter for a first plurality of service events, the labeled model training dataset being arranged according to a first data structure; obtaining an input dataset indicative of a second plurality of service events, the input dataset being arranged according to a second data structure different from the first data structure; transforming the input dataset into a transformed input dataset arranged according to the first data structure; and determining, by applying the supervised ML model to the transformed input dataset, a plurality of respective values of the service event trust parameter for the second plurality of service events.

Example 22. The one or more non-transitory computer readable media of Example 21, wherein the instructions, when executed by the one or more processors, further cause the one or more processors to perform operations comprising: training the supervised ML model to determine the values of the service event trust parameter for service events, based on the labeled model training dataset indicating the values of the service event trust parameter for the first plurality of service events.

Example 23. The one or more non-transitory computer readable media of Example 22, 12, wherein training the supervised ML model includes obtaining the labeled model training dataset by: obtaining a first dataset indicating the first plurality of service events associated with respective first entities; obtaining a second dataset indicating second entities associated with an indicator of distrust; comparing the first dataset to the second dataset to determine matches between the respective first entities and the second entities; and labeling the first plurality of service events with respective values of the service event trust parameter based on whether the respective first entities match the second entities, thereby producing the labeled model training dataset arranged according to the first data structure.

Example 24. The one or more non-transitory computer readable media of any one of Examples 21-23, wherein the service event trust parameter indicates whether respective entities associated with the first plurality of service events are associated with at least one instance of fraud or abuse.

Example 25. The one or more non-transitory computer readable media of any one of Examples 21-24, wherein a service event from among the second plurality of service events corresponds to a plurality of service actions by a service provider.

Example 26. The one or more non-transitory computer readable media of Example 25, wherein the plurality of service actions by the service provider serve different respective ones of a plurality of service recipients.

Example 27. The one or more non-transitory computer readable media of E any one of Examples 21-26, wherein determining the trust parameter value from among the plurality of respective values of the service event trust parameter includes determining a type of potential fraud or abuse associated with a corresponding service event from among the second plurality of service events.

Example 28. The one or more non-transitory computer readable media of any one of Examples 21-27, wherein transforming the input dataset includes removing one or more fields for each of the respective service events from among the second plurality of service events.

Example 29. The one or more non-transitory computer readable media of any one of Examples 21-28, wherein transforming the input dataset includes merging two or more service events from among the second plurality of service events.

Example 30. The one or more non-transitory computer readable media of any one of Examples 21-29, herein transforming the input dataset further includes modifying one or more values in the input dataset or one or more distributions of values in the input dataset.

### ADDITIONAL CONSIDERATIONS

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities.

Usually, though not necessarily, these quantities take the form of electrical, magnetic, or optical signals capable of being stored, transferred, combined, compared, and otherwise manipulated.

These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an,” “one or more,” and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component,” “a feature,” “one or more components,” “one or more features,” “a plurality of components,” “a plurality of features”).

Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component,” “artificial intelligence,” “artificial intelligence component”), or species thereof (e.g., “a large language model,” “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc., this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

1. A computer-implemented method comprising:
obtaining, by one or more processors, a supervised machine-learned (ML) model trained to determine values of a service event trust parameter for respective service events,
the supervised ML model being trained based on a labeled model training dataset including labels indicating values of the service event trust parameter for a first plurality of service events, the labeled model training dataset being arranged according to a first data structure, and
the service event trust parameter being a parameter indicating a likelihood of fraud or abuse in a corresponding service event;
obtaining, by the one or more processors, an input dataset indicative of a second plurality of service events, the input dataset being arranged according to a second data structure different from the first data structure;
transforming, by the one or more processors, the input dataset into a transformed input dataset arranged according to the first data structure,
wherein transforming the input dataset into the transformed input dataset includes rescaling values of one or more parameters from the input dataset such that distributions of the values of at least one of the one or more parameters align with distributions of corresponding values of at least one corresponding one or more parameters from the labeled model training dataset;
outputting, by the one or more processors applying the supervised ML model to the transformed input dataset, a plurality of respective values of the service event trust parameter for the second plurality of service events; and
in response to outputting the plurality of respective values of the service event trust parameter, associating, by the one or more processors, the plurality of respective values of the service event trust parameter with the transformed input dataset.

2. The computer-implemented method of claim 1, further comprising:
training, by the one or more processors, the supervised ML model to determine the values of the service event trust parameter for service events, based on the labeled model training dataset indicating the values of the service event trust parameter for the first plurality of service events.

3. The computer-implemented method of claim 2, wherein training the supervised ML model comprises obtaining the labeled model training dataset by:
obtaining a first dataset indicating the first plurality of service events associated with respective first entities;
obtaining a second dataset indicating second entities associated with an indicator of distrust;
comparing the first dataset to the second dataset to determine matches between the respective first entities and the second entities; and
labeling the first plurality of service events with respective values of the service event trust parameter based on whether the respective first entities match the second entities, thereby producing the labeled model training dataset arranged according to the first data structure.

4. The computer-implemented method of claim 1, wherein the service event trust parameter indicates whether respective entities associated with the first plurality of service events are associated with at least one instance of fraud or abuse.

5. The computer-implemented method of claim 1, wherein a service event from among the second plurality of service events corresponds to a plurality of service actions by a service provider.

6. The computer-implemented method of claim 5, wherein the plurality of service actions by the service provider serve different respective ones of a plurality of service recipients.

7. The computer-implemented method of claim 1, wherein determining a trust parameter value from among the plurality of respective values of the service event trust parameter includes determining a type of potential fraud or abuse associated with a corresponding service event from among the second plurality of service events.

8. The computer-implemented method of claim 1, wherein transforming the input dataset includes removing one or more fields for each of the respective service events from among the second plurality of service events.

9. The computer-implemented method of claim 1, wherein transforming the input dataset includes merging two or more service events from among the second plurality of service events.

10. (canceled)

11. A computing system comprising:
one or more processors; and
one or more non-transitory memories storing processor-executable instructions that, when executed by the one or more processors, cause the one or more processors to perform operations comprising:
obtaining a supervised machine-learned (ML) model trained to determine values of a service event trust parameter for respective service events,
the supervised ML model being trained based on a labeled model training dataset including labels indicating values of the service event trust parameter for a first plurality of service events, the labeled model training dataset being arranged according to a first data structure, and
the service event trust parameter being a parameter indicating a likelihood of fraud or abuse in a corresponding service event;
obtaining an input dataset indicative of a second plurality of service events, the input dataset being arranged according to a second data structure different from the first data structure;
transforming the input dataset into a transformed input dataset arranged according to the first data structure,
wherein transforming the input dataset into the transformed input dataset includes rescaling values of one or more parameters from the input dataset such that distributions of the values of at least one of the one or more parameters align with distributions of corresponding values of at least one corresponding one or more parameters from the labeled model training dataset;
outputting, by applying the supervised ML model to the transformed input dataset, a plurality of respective values of the service event trust parameter for the second plurality of service events; and
in response to outputting the plurality of respective values of the service event trust parameter, associating, by the one or more processors, the plurality of respective values of the service event trust parameter with the transformed input dataset.

12. The computing system of claim 11, wherein the instructions, when executed by the one or more processors, further cause the one or more processors to perform operations comprising:
training the supervised ML model to determine the values of the service event trust parameter for service events, based on the labeled model training dataset indicating the values of the service event trust parameter for the first plurality of service events.

13. The computing system of claim 12, wherein training the supervised ML model includes obtaining the labeled model training dataset by:
obtaining a first dataset indicating the first plurality of service events associated with respective first entities;
obtaining a second dataset indicating second entities associated with an indicator of distrust;
comparing the first dataset to the second dataset to determine matches between the respective first entities and the second entities; and
labeling the first plurality of service events with respective values of the service event trust parameter based on whether the respective first entities match the second entities, thereby producing the labeled model training dataset arranged according to the first data structure.

14. The computing system of claim 11, wherein the service event trust parameter indicates whether respective entities associated with the first plurality of service events are associated with at least one instance of fraud or abuse.

15. The computing system of claim 11, wherein a service event from among the second plurality of service events corresponds to a plurality of service actions by a service provider.

16. The computing system of claim 11, wherein determining the trust parameter value from among the plurality of respective values of the service event trust parameter includes determining a type of potential fraud or abuse associated with a corresponding service event from among the second plurality of service events.

17. The computing system of claim 11, wherein transforming the input dataset includes removing one or more fields for each of the respective service events from among the second plurality of service events.

18. The computing system of claim 11, wherein transforming the input dataset includes merging two or more service events from among the second plurality of service events.

19. (canceled)

20. One or more non-transitory computer-readable media storing processor-executable instructions that, when executed by one or more processors, cause the one or more processors to perform operations comprising:
obtaining a supervised machine-learned (ML) model trained to determine values of a service event trust parameter for respective service events,
the supervised ML model being trained based on a labeled model training dataset including labels indicating values of the service event trust parameter for a first plurality of service events, the labeled model training dataset being arranged according to a first data structure, and
the service event trust parameter being a parameter indicating a likelihood of fraud or abuse in a corresponding service event;
obtaining an input dataset indicative of a second plurality of service events, the input dataset being arranged according to a second data structure different from the first data structure;
transforming the input dataset into a transformed input dataset arranged according to the first data structure,
wherein transforming the input dataset into the transformed input dataset includes rescaling values of one or more parameters from the input dataset such that distributions of the values of at least one of the one or more parameters align with distributions of corresponding values of at least one corresponding one or more parameters from the labeled model training dataset;
outputting, by applying the supervised ML model to the transformed input dataset, a plurality of respective values of the service event trust parameter for the second plurality of service events; and
in response to outputting the plurality of respective values of the service event trust parameter, associating, by the one or more processors, the plurality of respective values of the service event trust parameter with the transformed input dataset.

21. The one or more non-transitory computer-readable media of claim 20, wherein the instructions, when executed by the one or more processors, further cause the one or more processors to perform operations comprising:
training the supervised ML model to determine the values of the service event trust parameter for service events, based on the labeled model training dataset indicating the values of the service event trust parameter for the first plurality of service events.

22. The one or more non-transitory computer-readable media of claim 20, wherein training the supervised ML model includes obtaining the labeled model training dataset by:
obtaining a first dataset indicating the first plurality of service events associated with respective first entities;
obtaining a second dataset indicating second entities associated with an indicator of distrust;
comparing the first dataset to the second dataset to determine matches between the respective first entities and the second entities; and
labeling the first plurality of service events with respective values of the service event trust parameter based on whether the respective first entities match the second entities, thereby producing the labeled model training dataset arranged according to the first data structure.
